(19) United States
(12) Patent Application Publication
(10) Pub. No.: US 2017/0144531 A1
(43) Pub. Date: May 25, 2017

(54) DRIVE SYSTEM FOR VEHICLE

(71) Applicant: TOYOTA JIDOSHA KABUSHIKI KAISHA, Toyota-shi (JP)

(72) Inventors: Tomoaki YANAGIDA, Susono-shi (JP); Yoshio ITO, Susono-shi (JP)

(73) Assignee: TOYOTA JIDOSHA KABUSHIKI KAISHA, Toyota-shi (JP)

(21) Appl. No.: 15/349,320

(22) Filed: Nov. 11, 2016

(30) Foreign Application Priority Data
Nov. 20, 2015 (JP) 2015-227677

(51) Int. Cl. B60K 6/48; B60K 6/543; B60L 11/18; B60L 11/14

(52) U.S. Cl. CPC B60K 6/48; B60L 11/14; B60K 6/543; B60L 11/1861; B60K 2006/4808; Y10S 903/913; Y10S 903/918; B60Y 2400/427; B60Y 2400/72; B60Y 2400/112; B60L 2220/52

(57) ABSTRACT

A drive system for a vehicle includes an engine, a torque converter that receives power from the engine, an output shaft that transmits torque, transmitted from the torque converter, to a drive wheel, a motor generator that is able to transmit power to the output shaft, and a first clutch provided between the engine and the torque converter and configured to allow or interrupt transmission of power between the engine and the torque converter.

### INCORPORATION BY REFERENCE

The disclosure of Japanese Patent Application No. 2015-227677 filed on Nov. 20, 2015 including the specification, drawings and abstract is incorporated herein by reference in its entirety.

### BACKGROUND

1. Technical Field

The disclosure relates to a drive system for a vehicle.

2. Description of Related Art

Japanese Patent Application Publication No. 2011-231844 (JP 2011-231844 A) describes a configuration in which a motor generator (MG) is provided as an auxiliary. JP 2011-231844 A describes a configuration in which the MG starts an engine or the MG drives a vehicle by changing a switching brake to a braking state and changing a drive wheel-side clutch to an engaged state.

### SUMMARY

When the engine in a stopped state is driven by the power of the MG, the MG is driven and an engine disconnection clutch is changed from a released state to a half-engaged state in a state where the engine is stopped. However, in a vehicle drive system in which a torque converter is arranged on an engine side, that is, on a downstream side, of an engine disconnection clutch in a path through which power is transmitted from an MG to an engine, when the engine in a stopped state is started by the power of the MG, the MG needs to not only increase the rotation speed of the engine but also increase the rotation speed of the torque converter.

In this case, in order to improve the durability of the engine disconnection clutch, the torque capacity of the engine disconnection clutch needs to be increased. That is, in order to protect the engine disconnection clutch by improving the durability of the engine disconnection clutch, the number of engagement elements of the clutch needs to be increased or the size of the clutch needs to be increased.

The disclosure provides a drive system for a vehicle, which is able to reduce torque that acts on an engine disconnection clutch at the time when an engine is started by a motor generator and which is able to prevent or reduce an increase in the number of engagement elements or an increase in the size of the engine disconnection clutch.

An example aspect of the present disclosure provides a drive system for a vehicle, the vehicle including a drive wheel. The drive system includes: an engine; a torque converter configured to receive power from the engine; an output shaft configured to transmit power, transmitted from the torque converter, to the drive wheel; a motor generator configured to transmit power to the output shaft; and a first clutch provided between the engine and the torque converter, the first clutch being configured to allow and interrupt transmission of power between the engine and the torque converter.

The drive system may further includes a second clutch. The second clutch may be provided between the motor generator and the output shaft. The second clutch may be configured to allow and interrupt transmission of power between the motor generator and the output shaft.

With this configuration, because the motor generator is allowed to be disconnected from the output shaft, it is possible to reduce a load on the output shaft by setting a second clutch in a released state during coasting.

In the drive system, the engine may be configured to transmit power to the motor generator.

With this configuration, because it is possible to drive the motor generator by using the driving force of the engine, it is possible to cause the motor generator to generate electric power.

The drive system may further includes a one-way clutch provided between the engine and the motor generator. The one-way clutch may be configured to allow transmission of power from the engine to the motor generator and block transmission of power from the motor generator to the engine.

With this configuration, because it is possible to interrupt transmission of power from the motor generator to the engine by using the one-way clutch, it is possible to avoid direct transmission of the power of the motor generator to the engine.

The drive system may further includes an electronic control unit. The electronic control unit may be configured to execute control for increasing a rotation speed of the engine by slip-engaging the first clutch and driving the motor generator, at the time when the engine is restarted while the vehicle is coasting in a state where the engine is stopped and the first clutch is in a released state.

With this configuration, because it is possible to transmit torque caused by the rotation of the output shaft to the engine at the time of restart of the engine when returning from coasting, it is possible to increase the rotation speed of the engine.

In the drive system, the torque converter may be include a lockup clutch. The electronic control unit may be configured to, at the time when the vehicle starts coasting, execute control for engaging the lockup clutch when the lockup clutch is in a released state.

With this configuration, because it is possible to prevent or reduce occurrence of differential rotation between a pump and a turbine in the torque converter by engaging the lockup clutch and it is possible to cause the torque converter to rotate while the vehicle is coasting, it is possible to efficiently transmit the torque of the output shaft to the engine at the time of restart of the engine.

In the drive system, the electronic control unit may be configured to execute control for releasing the first clutch when the rotation speed of the engine becomes higher than a rotation speed at which the engine is able to autonomously operate after executing control for increasing the rotation speed of the engine.

With this configuration, after the engine is able to autonomously operate, it is possible to quickly transmit the torque of the motor generator to the output shaft and the drive wheel.

With the drive system, the first clutch is located downstream of the torque converter in a path that transmits power from the motor generator to the engine, so, when the engine is started by the motor generator, it is possible to reduce torque that acts on the engaged first clutch, with the result that it is possible to prevent an increase in the size of the first clutch.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a skeletal view that shows the configuration of a vehicle including a vehicle drive system according to an embodiment;

FIG. 2 is a flowchart for illustrating a control method for the vehicle drive system according to the embodiment;

FIG. 3 is a timing chart for illustrating the control method for the vehicle drive system according to the embodiment;

FIG. 4 is a view that shows the schematic configuration of the vehicle drive system corresponding to FIG. 1;

FIG. 5 is a view that shows the schematic configuration of a vehicle drive system according to a comparative embodiment;

FIG. 6 is a view that shows the schematic configuration of a vehicle drive system according to a first alternative embodiment to the embodiment; and

FIG. 7 is a view that shows the schematic configuration of a vehicle drive system according to a second alternative embodiment to the embodiment.

### DETAILED DESCRIPTION OF EMBODIMENTS

Hereinafter, an embodiment will be described with reference to the accompanying drawings. In all the drawings of the embodiment, like reference numerals denote the same or corresponding portions. This disclosure is not limited by the embodiment that will be described below.

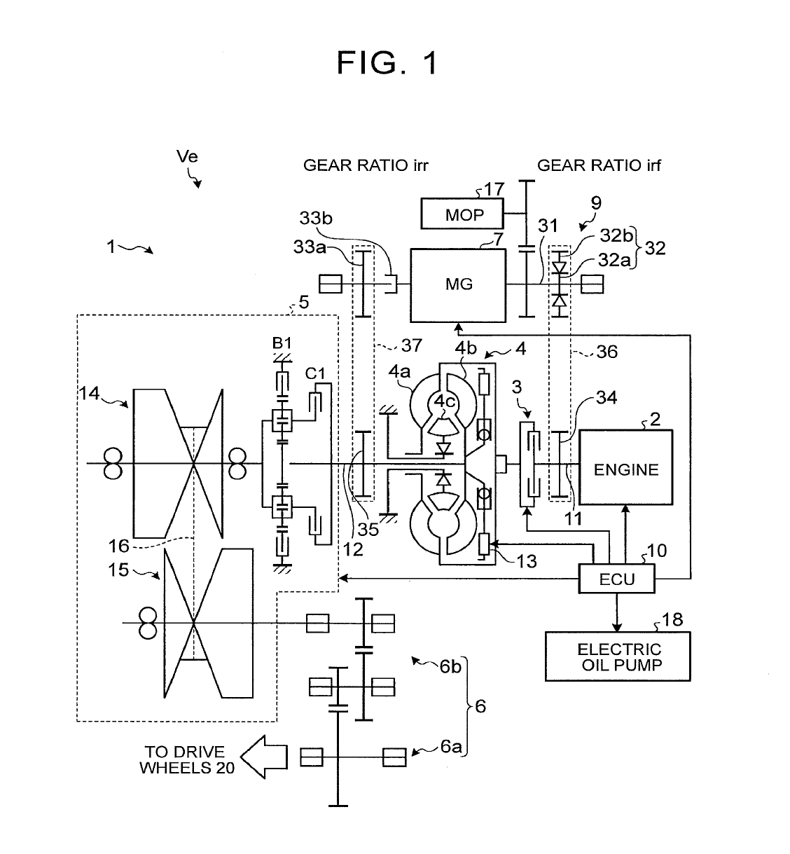

The configuration of a vehicle including a vehicle drive system according to the embodiment will be described. FIG. 1 shows the schematic configuration of the vehicle including the vehicle drive system according to the embodiment.

As shown in FIG. 1, the vehicle drive system 1 according to the embodiment is mounted on a vehicle Ve. The vehicle Ve includes a drive mechanism 9, an electronic control unit (ECU) 10 and an electric oil pump (EOP) 18. The drive mechanism 9 includes an engine 2, a first clutch (engine disconnection clutch) 3, a torque converter 4, a transmission mechanism 5, a reduction differential mechanism 6, a motor generator (MG) 7, a first power transmission unit 36 (first power transmission path) and a second power transmission unit 37 (second power transmission path).

Power output from the engine 2 is input to the transmission mechanism 5 via the first clutch 3 and the torque converter 4, and is transmitted from the transmission mechanism 5 to drive wheels 20 (not shown in FIG. 1) via the reduction differential mechanism 6. A power transmission path is provided between the engine 2 and the drive wheels 20.

The engine 2 is a power source of the vehicle Ve, and is able to convert the combustion energy of fuel to the rotational motion of a crankshaft (output shaft) 11 and then output the rotational motion. When the engine 2 is started, the engine 2 is, for example, cranked by the MG 7.

The first clutch 3 is arranged in a power transmission path between the engine 2 and the torque converter 4. The first clutch 3 is configured to be able to allow or interrupt transmission of power between the engine 2 and the torque converter 4. More specifically, the first clutch 3 is arranged between the crankshaft 11 of the engine 2 and the input shaft of the torque converter 4. The first clutch 3 is, for example, a friction engagement clutch device. When the first clutch 3 is placed in an engaged state, transmission of power between the engine 2 and the torque converter 4 is allowed, so the engine 2 is connected to the power transmission path. On the other hand, when the first clutch 3 is placed in a released state, transmission of power between the engine 2 and the torque converter 4 is interrupted, so the engine 2 is disconnected from the power transmission path.

The torque converter 4 is a fluid transmission device that transmits power, output from the engine 2, via hydraulic fluid (hydraulic oil). The torque converter 4 is arranged in a power transmission path between the first clutch 3 and the transmission mechanism 5. The torque converter 4 includes a pump impeller 4a, a turbine runner 4b and a stator 4c. The pump impeller 4a is connected to the crankshaft 11 of the engine 2, and is an input member to which power from the engine 2 is input. The turbine runner 4b is connected to an input shaft 12 of the transmission mechanism 5, and is an output member that outputs power input from the engine 2. The input shaft 12 of the transmission mechanism 5 functions as an output shaft that transmits power, which is transmitted from the torque converter 4, to the drive wheels 20. The stator 4c includes a one-way clutch, and has a torque amplification function.

The torque converter 4 includes a lockup clutch 13. When the lockup clutch 13 is placed in a released state, the torque converter 4 transmits power with the use of the pump impeller 4a and the turbine runner 4b via hydraulic oil. The pump impeller 4a is connected to the crankshaft 11 of the engine 2. The turbine runner 4b is connected to the input shaft 12 of the transmission mechanism 5. On the other hand, when the lockup clutch 13 is placed in an engaged state, the pump impeller 4a and the turbine runner 4b are directly coupled to each other, so the torque converter 4 directly transmits power with the use of the crankshaft 11 and the input shaft 12 not via hydraulic fluid.

The lockup clutch 13 is engaged or released under control over the hydraulic pressure of hydraulic oil that is supplied to the torque converter 4. The hydraulic pressure of hydraulic oil that is supplied to the torque converter 4 is controlled by a lockup control circuit (not shown). The lockup control circuit is able to couple the lockup clutch 13 in response to a control command from the ECU 10.

The transmission mechanism 5 has the function of shifting the speed of power output from the engine 2 via the torque converter 4. The transmission mechanism 5 is arranged in a power transmission path between the torque converter 4 and the reduction differential mechanism 6. In this embodiment, the transmission mechanism 5 is specifically a belt-type continuously variable transmission (CVT). The transmission mechanism 5 includes an engine 2-side primary pulley 14, a drive wheel-side secondary pulley 15 and a metallic belt 16. The metallic belt 16 is wound around the primary pulley 14 and the secondary pulley 15 so as to span between the primary pulley 14 and the secondary pulley 15, and transmits power. The transmission mechanism 5 controls an engaged/released state of each of a clutch C1 and a brake B1 as needed in response to a control command from the ECU 10, and changes the winding diameter of the metallic belt 16 by changing the V-groove width of the primary pulley 14 and the V-groove width of the secondary pulley 15. Thus, the transmission mechanism 5 changes its speed ratio (speed position). In accordance with a selected speed ratio, the transmission mechanism 5 shifts the speed of power input to the input shaft 12, and outputs the power toward the drive wheels 20.

The operations of the above-described first clutch 3, lockup clutch 13 of the torque converter 4 and transmission mechanism 5 (the pulleys 14, 15, the clutch C1 and the brake B1) are controlled by the hydraulic pressure of hydraulic oil that is supplied by a hydraulic controller (not shown). The hydraulic controller is able to control a change between an engaged state and a released state and the degree of the engaged state by adjusting hydraulic pressure that is supplied to the units in response to a control command from the ECU 10.

The reduction differential mechanism 6 is arranged in a power transmission path between the transmission mechanism 5 and the drive wheels 20. The reduction differential mechanism 6 includes a reduction mechanism 6a and a differential mechanism 6b, each of which is formed of a combination of gears. Rotation that is input from the transmission mechanism 5 is reduced in speed by the reduction differential mechanism 6, and is further distributed to the right and left drive wheels 20.

A mechanical oil pump (MOP) 17 and the EOP 18 each are a hydraulic supply source that supplies the hydraulic pressure of hydraulic oil to the first clutch 3, the lockup clutch 13 of the torque converter 4 and the transmission mechanism 5 (the pulleys 14, 15, the clutch C1 and the brake B1). The MOP 17 is driven by power that is transmitted from the engine 2 or the drive wheels 20 via the MG 7 by the drive mechanism 9. The EOP 18 is a hydraulic pump that is driven by a power source, such as a motor, that operates on electric power.

The drive mechanism 9 is a device for transmitting power to the MG 7. The drive mechanism 9 includes a transmission shaft 31, a one-way clutch 32, a pulley 33a, a second clutch (motor generator disconnection clutch) 33b, a first sprocket 34, a second sprocket 35, the first power transmission unit 36 and the second power transmission unit 37.

The transmission shaft 31 is coupled to the rotary shaft of the MG 7 so as to be integrally rotatable. The transmission shaft 31 is able to transmit power to the MG 7. The transmission shaft 31 is provided to extend across both sides of the rotary shaft of the MG 7 in the axial direction.

The one-way clutch 32 is provided at one end of the transmission shaft 31. The one-way clutch 32 includes an inner ring 32a and an outer ring 32b. When the rotation speed of the inner ring 32a is lower than the rotation speed of the outer ring 32b, the inner ring 32a and the outer ring 32b integrally rotate. When the rotation speed of the inner ring 32a is higher than or equal to the rotation speed of the outer ring 32b, the inner ring 32a and the outer ring 32b separately rotate. The inner ring 32a of the one-way clutch 32 is secured to the transmission shaft 31 so as to be integrally rotatable.

The second clutch 33b is provided at the other end of the transmission shaft 31. The second clutch 33b transmits or interrupts power through the transmission shaft 31 between the MG 7 and the input shaft 12 of the transmission mechanism 5. That is, the MG 7 is configured to be able to transmit power to the input shaft 12. When the second clutch 33b is placed in an engaged state, power is transmitted between the MG 7 and the input shaft 12 of the transmission mechanism 5. When the second clutch 33b is placed in a released state, power is interrupted between the MG 7 and the input shaft 12 of the transmission mechanism 5.

The first sprocket 34 is secured to the crankshaft 11 of the engine 2 so as to be integrally rotatable. That is, the first sprocket 34 is arranged in the first power transmission path between the engine 2 and the first clutch 3.

The second sprocket 35 is secured to the input shaft 12 of the transmission mechanism 5 so as to be integrally rotatable. That is, the second sprocket 35 is arranged in the second power transmission path between the torque converter 4 and the transmission mechanism 5.

The first power transmission unit 36 transmits power between the outer ring 32b of the one-way clutch 32 and the first sprocket 34. A chain that is wound around the outer ring 32b of the one-way clutch 32 and the first sprocket 34 is desirably applied as the first power transmission unit 36; however, the first power transmission unit 36 is not limited to the chain. For example, another element, such as a gear train, may be applied as the first power transmission unit 36. Thus, the first power transmission unit 36 is configured to be able to transmit power from the engine 2 through the first power transmission path to the MG 7 via the one-way clutch 32.

The second power transmission unit 37 transmits power between the second clutch 33b and the second sprocket 35. A chain that is wound around the second sprocket 35 and the pulley 33a coupled to the second clutch 33b is desirably applied as the second power transmission unit 37; however, the second power transmission unit 37 is not limited to the chain. For example, another element, such as a gear train, may be applied as the second power transmission unit 37. The second power transmission unit 37 transmits power from the drive wheels 20 through the second power transmission path to the MG 7 via the pulley 33a and the engaged second clutch 33b. Thus, the MG 7, or the like, is allowed to be driven from the drive wheels 20 side.

In a so-called two-way mechanism including two power transmission paths, that is, the first power transmission unit 36 and the second power transmission unit 37, for the MG 7, a gear ratio irf of the first power transmission unit 36 is larger than a gear ratio irr of the second power transmission unit 37.

In the drive mechanism 9, the first sprocket 34, the first power transmission unit 36 and the one-way clutch 32 constitute a first drive path that connects the crankshaft 11 of the engine 2 with the transmission shaft 31 of the MG 7. In this first drive path, owing to the function of the one-way clutch 32, transmission of power from the crankshaft 11 of the engine 2 to the transmission shaft 31 of the MG 7 is allowed, and transmission of power from the transmission shaft 31 to the crankshaft 11 is blocked (that is, the one-way clutch 32 rotates at idle).

In the drive mechanism 9, the second sprocket 35, the second power transmission unit 37, the pulley 33a and the second clutch 33b constitute a second drive path that connects the input shaft 12 of the transmission mechanism 5 with the transmission shaft 31 of the MG 7. In this second drive path, owing to the function of the second clutch 33b, power is transmitted or interrupted between the input shaft 12 of the transmission mechanism 5 and the transmission shaft 31 of the MG 7.

The ECU 10 that serves as a control unit is physically an electronic control unit mainly formed of a known microcomputer including a central processing unit (CPU), a random access memory (RAM), a read only memory (ROM), an interface, and the like. Each function of the above-described ECU 10 is implemented by causing various devices in the vehicle Ve to operate under control of the CPU by loading an application program held in the ROM onto the RAM and executing the application program on the CPU, and reading data in the RAM or the ROM and writing data to the RAM.

The ECU 10 controls the units of the vehicle Ve, such as the engine, the first clutch 3, the torque converter 4 and the transmission mechanism 5, on the basis of a driver's operation state of the engine 2 and an operating state of the engine 2. Thus, the ECU 10 generally controls travel of the vehicle Ve. The ECU 10 executes free running control by controlling the units of the vehicle Ve.

In free running control, for improvement in fuel economy, the engine 2 is automatically stopped while the vehicle Ve is traveling, and then the vehicle Ve is caused to coast. In free running control, in order to prevent transmission of shock due to a stop of the engine 2, the first clutch 3 is released at the time when the engine 2 is stopped. In other words, free running means that, while the vehicle Ve is traveling, transmission of power between the engine 2 and the transmission mechanism 5 is interrupted by releasing the first clutch 3, and the vehicle Ve is caused to coast in a state where the engine 2 is stopped. In this free running control, because fuel consumption in the engine 2 stops, so it is possible to improve fuel economy.

When an engine automatic stop condition (for example, a state where an accelerator is in an off state and a brake is in an off state, or the like) is satisfied while the vehicle Ve is traveling, the ECU 10 executes free running control by releasing the first clutch 3 and automatically stopping the engine 2. When the ECU 10 automatically stops the engine 2, the ECU 10 stops supply of fuel to the engine 2 and ignition of fuel. When an engine automatic start condition (for example, an accelerator pedal is depressed by a driver, or the like) is satisfied while free running control is being executed, the ECU 10 returns from free running by engaging the first clutch 3 and starting the engine 2.

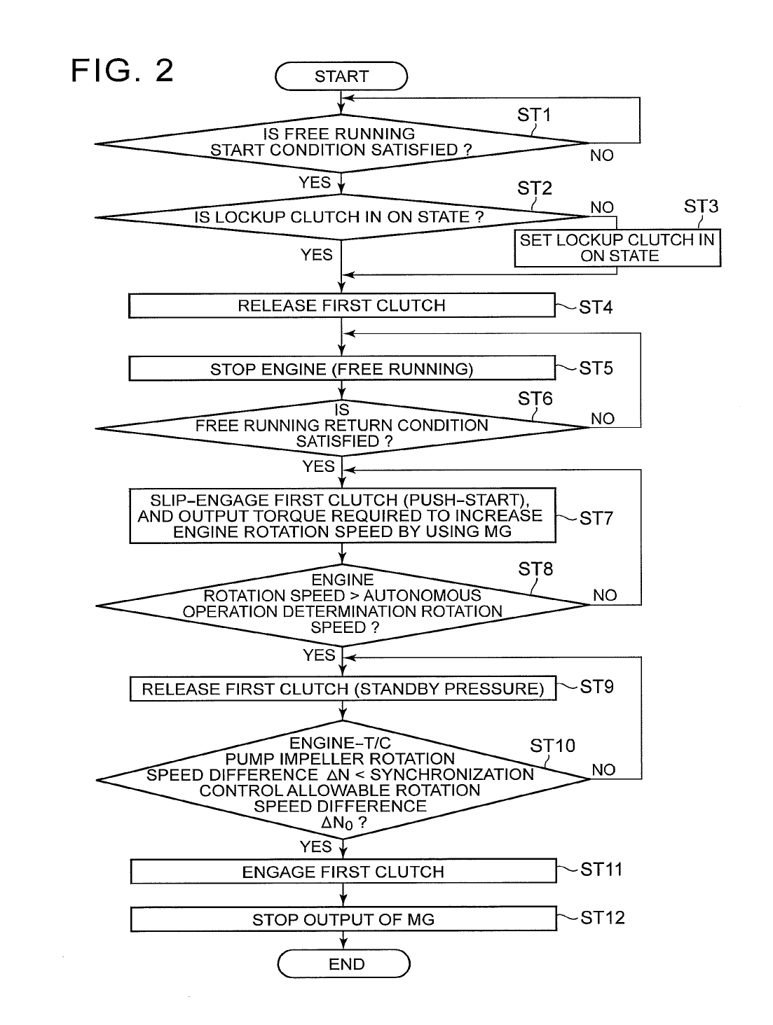

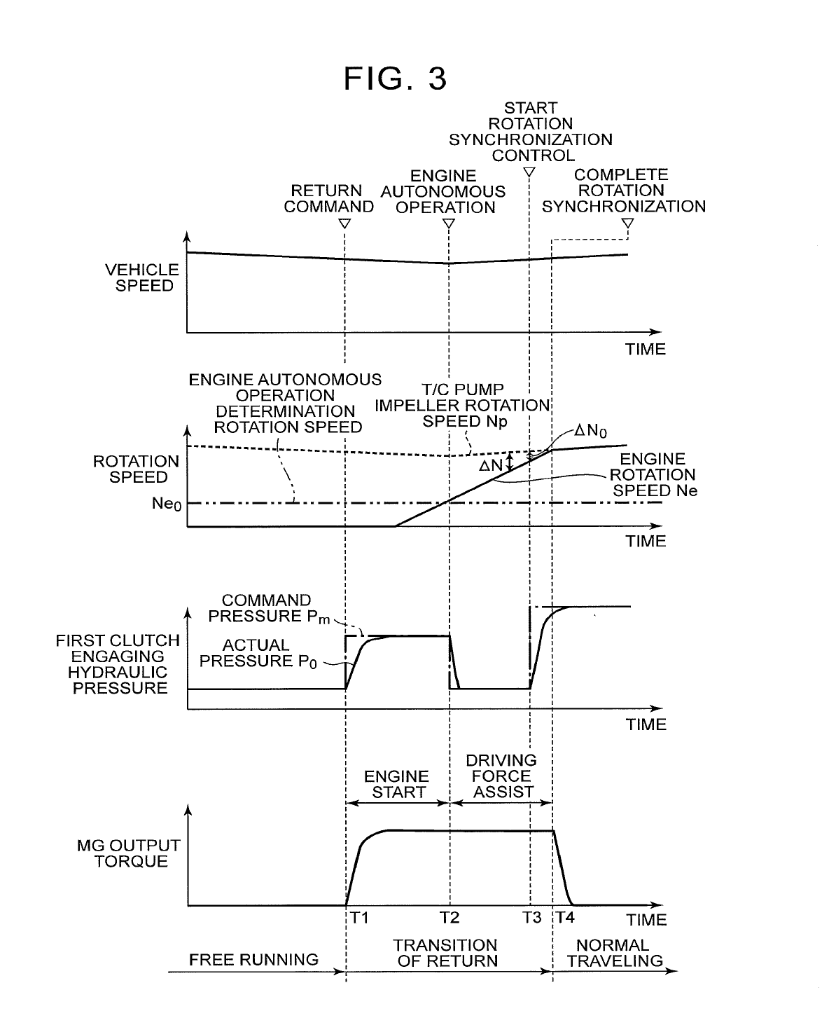

Next, free running control according to the embodiment will be described. FIG. 2 is a flowchart that shows an example of free running control according to the embodiment. FIG. 3 is a timing chart that shows a traveling state of the vehicle Ve according to the embodiment. The ECU 10 executes the control flowchart shown in FIG. 2 in a state where the vehicle Ve is controlled to a normal traveling state. In the normal traveling state, the vehicle Ve is caused to travel forward by the power of the engine 2 by setting the first clutch 3 in the engaged state.

In step ST1, while the vehicle Ve is normally traveling, the ECU 10 determines whether a free running start condition is satisfied. The free running start condition is a condition for causing the vehicle Ve to start free running (coasting). The free running start condition may include various conditions, such as a condition in which driver's accelerator operation is off while the vehicle Ve is traveling forward at a vehicle speed V higher than or equal to a predetermined vehicle speed VM, a condition in which it has been detected that driver's brake operation is off and a condition in which an oil temperature of a transmission falls within a predetermined condition.

In step ST1, the ECU 10 executes determination process until the free running start condition is satisfied (No in step ST1). When the free running start condition is satisfied (Yes in step ST1), the process proceeds to step ST2. In step ST2, the ECU 10 determines whether the lockup clutch 13 of the torque converter 4 is in an on state. When the ECU 10 determines that the lockup clutch 13 is in an off state, that is, a released state (No in step ST2), the process proceeds to step ST3. In step ST3, the ECU 10 controls the lockup clutch 13 such that the lockup clutch 13 is engaged. After that, the process proceeds to step ST4. In step ST2, when the ECU 10 determines that the lockup clutch 13 is the on state, that is, the engaged state (Yes in step ST2), the process proceeds to step ST4.

In step ST4, after the ECU 10 executes control for releasing the first clutch 3, the process proceeds to step ST5. In step ST5, the ECU 10, for example, stops supply of fuel to the engine 2 and ignition of fuel, thus stopping the engine 2. As a result, the vehicle Ve enters a free running state. In step ST4, the second clutch 33b is desirably placed in the engaged state; however, the second clutch 33b may be placed in the released state.

As shown in FIG. 3, the vehicle speed V may gradually decrease during free running. In this case, the rotation speed of the pump impeller 4a of the torque converter 4 also gradually decreases. While the vehicle Ve is in a free running state, the process proceeds to step ST6 shown in FIG. 2.

In step ST6, the ECU 10 determines whether a condition for returning from the free running state to the normal traveling state (free running return condition) is satisfied. The free running return condition includes the case where the accelerator is in an on state and the case where the brake is in an on state. The case where the accelerator is in the on state is a state where the driver has depressed the accelerator pedal and is a state where the accelerator operation amount is larger than zero. The case where the brake is in the on state is a state where the driver has depressed the brake pedal, and is a state where a brake depression force or a brake stroke amount is larger than zero. The free running return condition may include a consumption electric power, a state of charge (SOC) of a battery, an oil temperature of the transmission, or the like. These are free running return commands based on a system request. During free running in step ST5 and step ST6, as shown in FIG. 3, the first clutch 3 keeps the released state, and the hydraulic pressure that is supplied to the first clutch 3 is kept at a hydraulic pressure that does not provide any stroke.

After that, when the ECU 10 determines that the free running return condition is satisfied (Yes in step ST6), the process proceeds to step ST7 shown in FIG. 2. On the other hand, when the free running return condition is not satisfied (No in step ST6), the ECU 10 returns to step ST5, and repeats the processes of step ST5 and step ST6.

As the process proceeds to step ST7, the ECU 10 executes control for slip-engaging the first clutch 3. Thus, rotational driving force is transmitted from the drive wheels 20 to the engine 2, and so-called push-start is performed. At the same time, the ECU 10 causes the MG 7 to perform power running. The MG 7 outputs torque required to increase the rotation speed of the engine 2. When the second clutch 33b is in the released state in the free running state, the ECU 10 executes control for engaging the second clutch 33b.

In the process of step ST7, as in the case from a return command at the portion of a transition of return shown in FIG. 3 to autonomous operation of the engine 2 (engine autonomous operation in FIG. 3) (time T1 to time T2), the ECU 10 controls the hydraulic circuit such that a predetermined hydraulic pressure is supplied to the first clutch 3 (the alternate long and short dashed line in FIG. 3, command pressure Pₘ). An actual hydraulic pressure that is supplied to the first clutch 3 increases with a slight delay as indicated by actual pressure P₁ (the wide continuous line in FIG. 3). The ECU 10 calculates the torque of the first clutch 3, and causes the MG 7 to output torque through power running. As the first clutch 3 is slip-engaged and torque is transmitted from the MG 7 to the engine 2, the rotation speed of the engine 2 (narrow continuous line in FIG. 3) gradually increases. In an interval (time T1 to time T2) of engine start in FIG. 3, the engine 2 is started so as to autonomously operate. After that, the process proceeds to step ST8 shown in FIG. 2.

In step ST8, the ECU 10 determines whether the rotation speed of the engine 2 is higher than a rotation speed at which the engine 2 is able to autonomously operate (engine autonomous operation determination rotation speed Ne₀). When the ECU 10 determines that the rotation speed of the engine 2 is higher than the engine autonomous operation determination rotation speed Ne₀ (Yes in step ST8), the process proceeds to step ST9. Autonomous operation is an autonomously rotatable state where combustion takes place in each cylinder of the engine 2 and the engine 2 autonomously burns fuel. On the other hand, when the ECU 10 determines that the rotation speed of the engine 2 is lower than or equal to the engine autonomous operation determination rotation speed Ne₀ (No in step ST8), the ECU 10 returns to step ST7. The ECU 10 repeats the processes of step ST7 and step ST8 until the ECU 10 determines that the rotation speed of the engine 2 is higher than the engine autonomous operation determination rotation speed Ne₀.

As the process proceeds to step ST9, the ECU 10 executes control for releasing the first clutch 3. In the process of step ST9, as in the case after the start of autonomous operation of the engine 2 in the transition of return in FIG. 3 (from time T2), the ECU 10 controls the hydraulic pressure (engaging hydraulic pressure) that is supplied to the first clutch 3 to a hydraulic pressure (standby pressure) for keeping the released state (the alternate long and short dashed line in FIG. 3, command pressure Pₘ). An actual hydraulic pressure that is supplied to the first clutch 3 decreases to the standby pressure with a slight delay as indicated by the actual pressure P₁ (the wide continuous line in FIG. 3). As the first clutch 3 is released, the driving force of the drive wheels 20 is assisted by power running of the MG 7.

This is because, when the first clutch 3 is kept in the engaged state in a state where the rotation speed of the engine 2 is the rotation speed at which the engine 2 is able to autonomously operate, the torque of the MG 7 is used to increase the rotation speed of the engine 2. That is, when the rotation speed of the engine 2 is the rotation speed at which the engine 2 is able to autonomously operate, it is possible to transmit the torque of the MG 7 to the drive wheels 20 with high response by releasing the first clutch 3.

After the process of step ST9, the process proceeds to step ST10 shown in FIG. 2. In step ST10, the ECU 10 determines whether a rotation speed difference ΔN (=Np−Ne) between the rotation speed Ne of the engine 2 and the rotation speed Np of the pump impeller 4a of the torque converter 4 is smaller than a predetermined rotation speed difference at or below which it is determined that rotation synchronization control is allowed to be started (synchronization control allowable rotation speed difference ΔN₀) The synchronization control allowable rotation speed difference ΔN₀ is set in consideration of the response of the actual pressure P₁ (the wide continuous line in FIG. 3) to the rate of increase in the rotation speed Ne of the engine 2 and the command pressure Pₘ (the alternate long and short dashed line in FIG. 3) of hydraulic pressure in the first clutch 3.

In step ST10, when the ECU 10 determines that the rotation speed difference ΔN between the rotation speed Ne of the engine 2 and the rotation speed Np of the pump impeller 4a is smaller than the synchronization control allowable rotation speed difference ΔN₀ (ΔN<ΔN₀) (Yes in step ST10), the process proceeds to step ST11. On the other hand, when the ECU 10 determines that the rotation speed difference ΔN is larger than or equal to the synchronization control allowable rotation speed difference ΔN₀ (ΔN≧ΔN₀) (No in step ST10), the process returns to step ST9. The ECU 10 repeats the processes of step ST9 and step ST10 until the ECU 10 determines that the rotation speed difference ΔN is smaller than the synchronization control allowable rotation speed difference ΔN₀.

In step ST11, the ECU 10 executes control for engaging the first clutch 3. In the process of step ST11, as in the case from the start of rotation synchronization control to completion of rotation synchronization (time T3 to time T4) in the time period of the transition of return shown in FIG. 3, the ECU 10 controls the hydraulic circuit such that a predetermined hydraulic pressure is supplied to the first clutch 3 (the alternate long and short dashed line in FIG. 3, command pressure). The actual hydraulic pressure that is supplied to the first clutch 3 increases with a slight delay as indicated by the wide continuous line (actual pressure) in FIG. 3. As described above, the synchronization control allowable rotation speed difference ΔN₀ is set in consideration of the rate of increase in the rotation speed Ne of the engine 2 and the response of hydraulic pressure in the first clutch 3. For this reason, by the time the first clutch 3 is completely placed in the engaged state, the rotation speed Ne of the engine 2 and the rotation speed Np of the pump impeller 4a substantially coincide with each other. Thus, the rotation speeds of the engagement elements in the first clutch 3 also substantially coincide with each other, so it is possible to prevent or reduce engagement shock of the first clutch 3, and it is possible to prevent or reduce so-called pull-in feeling. After that, the process proceeds to step ST12 shown in FIG. 2.

In step ST12, the ECU 10 executes control for stopping the output of the torque of the MG 7. In the process of step ST12, as shown at the portion of normal traveling (from time T4) in FIG. 3, the ECU 10 sets the torque, which is output from the MG 7, to zero. In this case, the vehicle Ve returns to normal traveling, and the MG 7 is regeneratively driven by the engine 2 to function as a generator. As described above, as the vehicle Ve returns from free running to normal traveling under control of the ECU 10, the control routine ends.

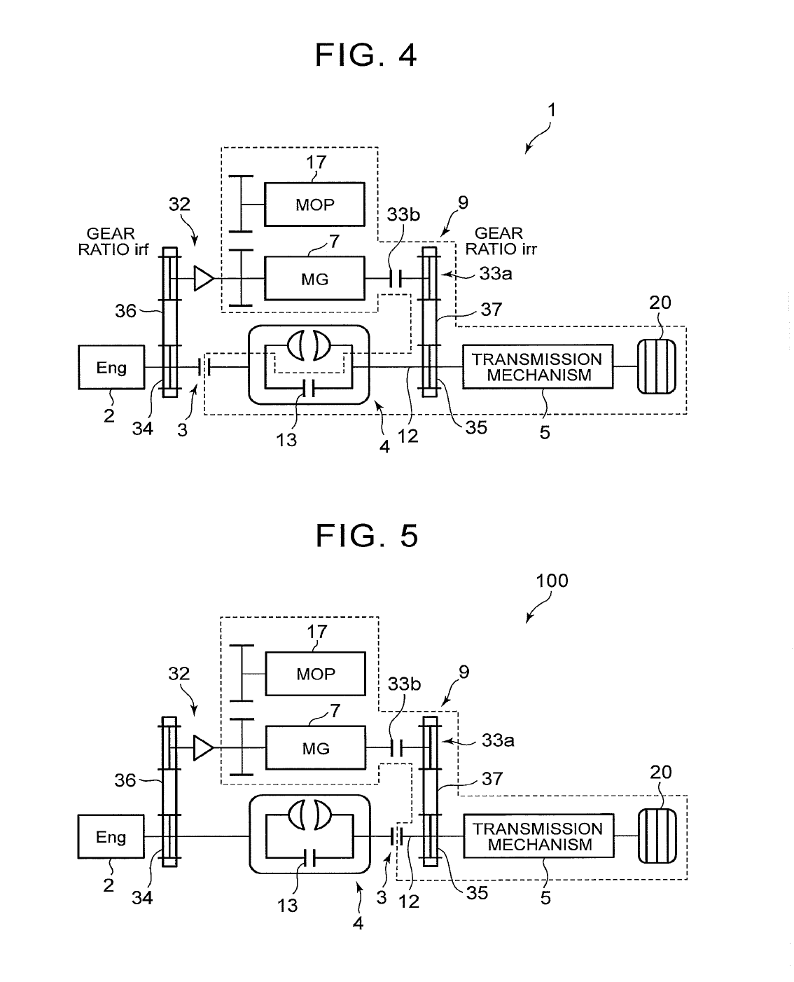

FIG. 4 is a schematic diagram that schematically shows the characterized portion of the vehicle drive system 1 shown in FIG. 1. FIG. 5 is a schematic diagram that schematically shows a vehicle drive system 100 according to a comparative embodiment.

As shown in FIG. 5, in the vehicle drive system 100 according to the comparative embodiment, the first clutch 3 is arranged between the transmission mechanism 5 and the torque converter 4. While the vehicle Ve is in a free running state, the drive wheels 20, the transmission mechanism 5, the input shaft 12, the second power transmission unit 37, the MG 7, and the like (surrounded by the dashed line in FIG. 5) are driven. On the other hand, at the time when the vehicle Ve returns from free running, power from the drive wheels 20 and the power of the MG 7 are transmitted to the engine 2 by setting the first clutch 3 in the engaged state in the vehicle drive system 100, thus restarting the engine 2. The power of the MG 7 is transmitted to the engine 2 via the second power transmission unit 37, the first clutch 3 and the torque converter 4. As a result, at the time of restart of the engine 2, not only torque for driving the engine 2 but also torque for increasing the rotation speed of the torque converter 4 acts on the first clutch 3, so a torque capacity assigned to the first clutch 3 also increases.

As the torque that acts on the first clutch 3 increases, measures, such as increasing the number of clutch plates as engagement elements and increasing the size of the first clutch 3, are required in order to ensure thermal resistance. As for the measures, a method in which the one-way clutch 32 that is connected to the MG 7 on the engine 2 side is replaced with an ordinary friction engagement clutch or a dog clutch. However, this method leads to a significant increase in cost. Furthermore, a method of interchanging the one-way clutch 32 and the second clutch 33b is also conceivable. However, with this method, when the vehicle Ve returns from free running as a result of driver's depression of the accelerator, it is difficult to immediately transmit torque from the MG 7 to the input shaft 12 at the time of restart of the engine 2 by using the MG 7.

In contrast, with the vehicle drive system 1 according to the above-described embodiment shown in FIG. 4, the first clutch 3 is arranged in the first power transmission path between the engine 2 and the torque converter 4. While the vehicle Ve is in a free running state, the lockup clutch 13 is placed in the engaged state, so, in addition to the drive wheels 20, the transmission mechanism 5, the input shaft 12, the second power transmission unit 37, the MG 7, and the like, the torque converter 4 (surrounded by the dashed line in FIG. 4) is driven. At the time when the vehicle Ve returns from free running, the power of the MG 7 is transmitted to the engine 2 by setting the first clutch 3 in a slip-engaged state in the vehicle drive system 1, thus restarting the engine 2. In this case, power from the MG 7 is transmitted to the engine 2 via the second power transmission unit 37, the torque converter 4 in which the lockup clutch 13 is placed in the engaged state, and the first clutch 3. That is, at the time of restart of the engine 2 by using the MG 7, torque for increasing the rotation of the torque converter 4 does not act on the first clutch 3. Thus, torque that acts on the first clutch 3 at the time of restart of the engine 2 is reduced as compared to the comparative embodiment.

When the torque that acts on the first clutch 3 is reduced, it is possible to reduce the number of clutch plates as the engagement elements, so it is possible to reduce the size of the first clutch 3. Because it is possible to reduce inertia that is increased by the MG 7, it is possible to improve response in restart of the engine 2. At the time of return from free running, the MOP 17 rotates at a low rotation speed. When the MOP 17 rotates at a low rotation speed, the flow rate of hydraulic oil that is discharged from the MOP 17 becomes shorter than the flow rate of hydraulic oil, which is required in the vehicle Ve, so this shortage of the flow rate is compensated by driving the EOP 18. In the embodiment, torque required to restart the engine 2 is reduced, so it is possible to also reduce required hydraulic pressure of hydraulic oil. As a result, it is possible to reduce the electric power consumption of the EOP 18.

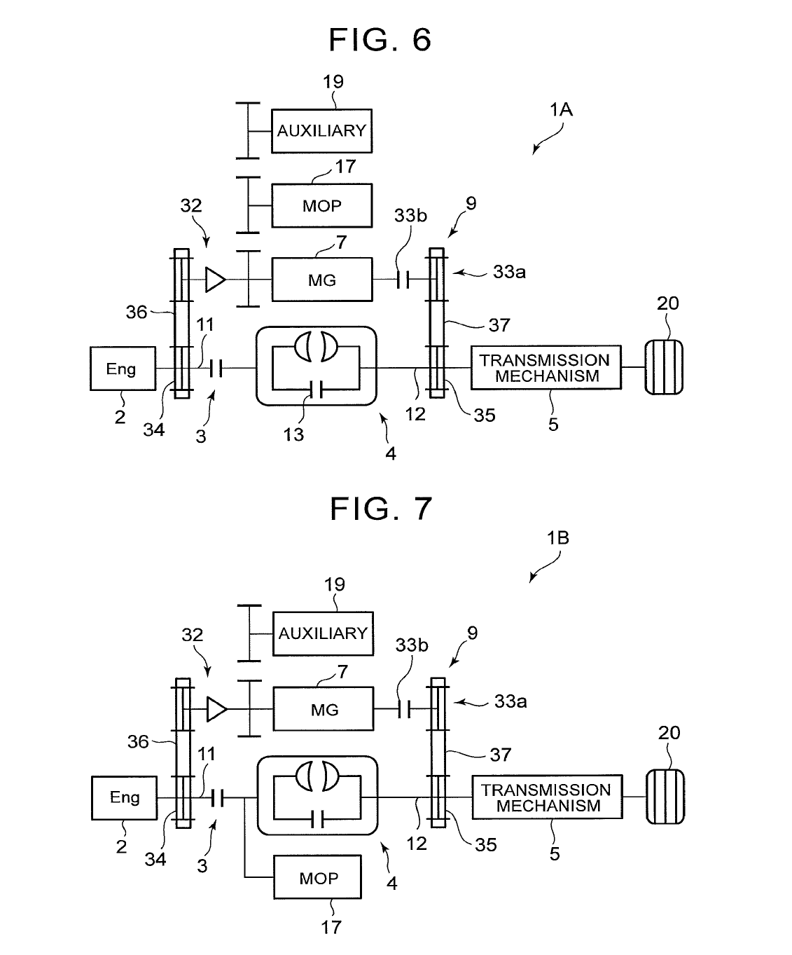

Next, an alternative embodiment to the above-described embodiment will be described. FIG. 6 is a schematic diagram that shows a vehicle drive system according to a first alternative embodiment. As shown in FIG. 6, in the vehicle drive system 1A according to the first alternative embodiment, an auxiliary 19 is mounted on an axis parallel with an axis of the MG 7 and the MOP 17. For example, an air-conditioner compressor, a brake negative pressure generating device (vacuum pump), a power steering pump, or the like, may be applied as the auxiliary 19. When the auxiliary 19 is mounted as described above, it is possible to ensure the performance of the vehicle Ve even during free running. The other configuration is similar to the vehicle drive system 1 according to the embodiment.

FIG. 7 is a schematic view that shows a vehicle drive system according to a second alternative embodiment. As shown in FIG. 7, in the vehicle drive system 1B according to the second alternative embodiment, a similar auxiliary 19 to that of the first alternative embodiment is mounted on an axis parallel with an axis of the MG 7. The MOP 17 is coupled to a shaft between the first clutch 3 and the torque converter 4. With this configuration, it is possible to drive the MOP 17 even during free running. The other configuration is similar to the vehicle drive system 1 according to the embodiment.

The embodiment is specifically described; however, the disclosure is not limited to the above-described embodiment. Various modifications based on the technical idea of the disclosure are applicable. For example, numeric values in the above-described embodiment are only illustrative, and numeric values different from those values may be used as needed.

The transmission mechanism 5 of the vehicle drive system 1 is not limited to a belt-type CVT. Various types may be employed as the transmission mechanism 5 as long as a vehicle includes a torque converter. Specifically, for example, a stepped automatic transmission (AT) that changes a speed position in response to the traveling state of the vehicle Ve may be employed.

What is claimed is:

1. A drive system for a vehicle, the vehicle including a drive wheel, the drive system comprising:
an engine;
a torque converter configured to receive power from the engine;
an output shaft configured to transmit power, transmitted from the torque converter, to the drive wheel;
a motor generator configured to transmit power to the output shaft; and
a first clutch provided between the engine and the torque converter, the first clutch being configured to allow and interrupt transmission of power between the engine and the torque converter.

2. The drive system according to claim 1, further comprising:
a second clutch provided between the motor generator and the output shaft, the second clutch being configured to allow and interrupt transmission of power between the motor generator and the output shaft.

3. The drive system according to claim 1, wherein
the engine is configured to transmit power to the motor generator.

4. The drive system according to claim 1, further comprising:
a one-way clutch provided between the engine and the motor generator,
the one-way clutch being configured to allow transmission of power from the engine to the motor generator and block transmission of power from the motor generator to the engine.

5. The drive system according to claim 1, further comprising:
an electronic control unit configured to execute control for increasing a rotation speed of the engine by slip-engaging the first clutch and driving the motor generator, at the time when the engine is restarted while the vehicle is coasting in a state where the engine is stopped and the first clutch is in a released state.

6. The drive system according to claim 5, wherein
the torque converter includes a lockup clutch, and
the electronic control unit is configured to, at the time when the vehicle starts coasting, execute control for engaging the lockup clutch when the lockup clutch is in a released state.

7. The drive system according to claim 5, wherein
the electronic control unit is configured to execute control for releasing the first clutch when the rotation speed of the engine becomes higher than a rotation speed at which the engine is able to autonomously operate after executing control for increasing the rotation speed of the engine.
